(19) United States
(12) Patent Application Publication
(10) Pub. No.: US 2024/0402878 A1
(43) Pub. Date: Dec. 5, 2024

(54) SYSTEMS, METHODS, AND GRAPHICAL USER INTERFACES FOR MANAGING AND SHARING INFORMATION ASSOCIATED WITH A DIGITAL LOG OF EXTRACURRICULAR ACTIVITIES

(71) Applicant: ESPAR CONSULTING, Chesterfield, MO (US)

(72) Inventors: Nagendra Sanjeeva, Chesterfield, MO (US); Prasanna G. Hedge, Bangalore (IN)

(21) Appl. No.: 18/205,892

(22) Filed: Jun. 5, 2023

(51) Int. Cl. G06F 3/0482

(52) U.S. Cl. CPC G06F 3/0482

(57) ABSTRACT

The present disclosure is for systems, methods and graphical user interfaces for processing and management of extracurricular activity information. Graphical user interfaces may be used to obtain activity information via templates designed to standardize the information for a given activity obtained and logged across a plurality of users. The logged activity information may be presented via a graphical user interface designed to present information in a standardized format based on activity such that viewing activity information across a plurality of users allows for easier and more efficient comparison of activities between users. The logged activity may comprise a verification status which may also be presented via the graphical user interface thereby providing an indication of the authenticity of the logged activity information.

### BACKGROUND

Currently, achievements in extracurricular activities (Arts, Dance, Sports, Martial Arts, Scouts, Volunteering, Activities of School/College Clubs and Fraternities, and others) are showcased by combination of physical objects such as trophies, medals, certificates, and social sharing, and recently, through digital certificates using open badges specification. There's no integrated process and a dedicated digital solution to track achievements throughout a user's lifetime with digital validation of the authority (organizers, academics, businesses, clubs, coaches) that awarded them. There's no standard scale and a standardized catalog to benchmark and compare achievement levels across a diverse set of extracurricular skills.

There is no fit-for-purpose digital solution to track and manage users' lifetime achievements across all their skills. For instance, achievements and recognitions are recorded in various forms, including paper-based certificates, trophies, medals, written endorsements, social sharing, etc. Different social media platforms such as Facebook and Linked In, which aren't designed for this purpose, are being used to showcase achievements as part of social acceptance.

As can be seen, there is a need for improved systems, methods, and apparatus that enables coaches/organizations/businesses/academies/school clubs (collectively called organizations) and their members to maintain a digital log of all their activities and events, active and inactive member status, and participation details.

### SUMMARY

The present invention addresses the above issues in the form of systems, methods, and graphical user interfaces for obtaining, managing, and displaying extracurricular activity information (e.g. skills, achievements, recurring actions, etc.) for a plurality of users. Users, such as activity participants, record or log activity information using an extracurricular activities platform. The process of logging activity may comprise users providing information associated with an activity (e.g. a skill, an achievement, recurring actions such as training or practice, etc.) using a standardized template for that activity. The templates may be determined by organizations associated with the activity and the most relevant and/or common information those organizations obtain and/or request from their participants. The templates may be updated over time as information associated with an activity changes over time as determined from organization-based template preferences. This process serves to standardize the information obtained across a plurality of users and/or organizations for a given activity or activity type.

Logged activity information may be presented via at least one graphical user interface designed to present information in a standardized format based on activity such that viewing activity information across a plurality of users allows for easier and more efficient comparison of activities between users. The logged activity may comprise a verification status which may also be presented via the graphical user interface thereby providing an indication of the authenticity of the logged activity information. Verification status may comprise verification (e.g. certification, endorsement, etc.) by an organization overseeing or providing instruction associated with the activity. Users such as activity participants may request verification from an organization for associated activities. The verification information may comprise information about the verifying entity (e.g. organization) such information providing an indication of the degree of experience, expertise, reputation and recognition of the organization. In this way, activity information associated with a user may not only be verified (which in itself provides improved authenticity), but additional information about the verifying entity provides a further degree of authenticity associated with the verification. Ultimately, through this invention, trustworthiness in extracurricular activity information is greatly improved and in combination with the standardization of information for each activity, the comparison of extracurricular activities between different users becomes easier, more efficient, and has more value as compared to traditional extracurricular activity documentation which lacks standardization and verification/authenticity measures.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for extracurricular activity logging and sharing in accordance with an exemplary embodiment of the invention.

FIG. 2 illustrates a system for extracurricular activities platform in accordance with an exemplary embodiment of the present invention.

FIGS. 3A-3D illustrate exemplary graphical user interfaces for use in an extracurricular activities platform according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

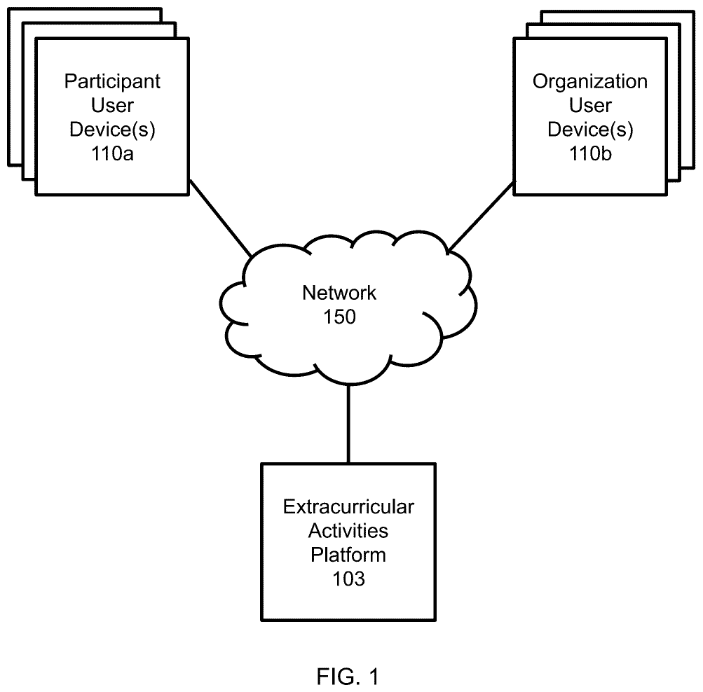

FIG. 1 illustrates an exemplary embodiment of a system for extracurricular activity logging and sharing. The system includes participant user device(s) 110a, organization user device(s) 110b, extracurricular activities platform 103, and a network 150 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

Participant user device(s) 110a generally comprise any user device an individual uses in association with logging their extracurricular activities. Participant user device(s) 110a may be used to provide information associated with at least one user extracurricular activity such as by providing information to update a user profile. Participant user device(s) 110a may provide information in association with a template associated with the extracurricular activities platform such that the participant user provides (or is requested to provide) certain information associated with a given activity as determined by the template. In one aspect, participant user device(s) 110a may be used to provide information for generating a template for a given activity.

Organization user device(s) 110b generally comprise any user device an individual uses in association with managing extracurricular activities associated with the organization. In general, an organization may comprise foundations, businesses, academies, clubs, school clubs, training centers, a coach(es), an instructor(s), an athletic team, an athletic league, professional associations and/or organizations, etc. This list is merely exemplary and organizations may comprise other entities having an association with extracurricular activities of other individuals as would be apparent to one of ordinary skill in the art. Organization user device(s) 110b may provide information associated with at least one of establishing templates for activities associated with the organization, verifying participant information (endorsements/certifications), and managing events and/or activity sessions (e.g. a series of classes, a tournaments, etc.).

Extracurricular activities platform 103 is operable to obtain extracurricular activity information from at least one of participant user device(s) 110a and organization user device(s) 110b and manage the information and presentation thereof via at least one graphical user interface (GUI). Extracurricular activities platform 103 may obtain extracurricular activity information from participant user device(s) 110a based on templates established by the extracurricular platform. Extracurricular activities platform 103 may generate at least one template for at least one activity based on information obtained from at least one of participant user device(s) 110a and organization user device(s) 110b. Extracurricular activities platform 103 may generate at least one GUI for each template wherein the GUI may be used for at least one of obtaining information and presenting and/or sharing information associated with an activity. Extracurricular activities platform 103 may obtain endorsement information associated with activities. Endorsement information may comprise a request from a participant for verification (e.g. endorsement and/or certification) of an associated participant activity. Endorsement information may comprise a verification (e.g. endorsement and/or certification) from an organization verifying the participation information associated with an activity for at least one participant user. In this way, the extracurricular activities platform manages a log of user activities along with verification status information associated with the activities thereby providing a degree of trustworthiness associated with the information. In one aspect, extracurricular activities platform 103 logs statistics associated with organizations including, but not limited to, at least one of past activities provided by, hosted by, or overseen by an organization, past participants, past endorsements/certifications provided by an organization, ongoing activities provided by, hosted by, or overseen by an organization, and awards or recognition associated with the organization. Extracurricular activities platform 103 may use these statistics in computing an organization score indicative of the organization's experience, expertise, and/or reputation which may provide an added measure of trustworthiness or value of verifications provided by the organization.

Although depicted as separate user devices, participant and organization user devices may comprise the same user device(s). For example, when one user is associated with an organization (e.g. leads or is responsible for a given activity) and also participates in other activities associated with other organizations, that user may use the same user device for accessing the platform as both a participant user and an organization user. Furthermore, the system may comprise other user devices (not depicted) such as those of users outside the participants and organizations directly interacting with the platform with whom the extracurricular activity information is shared.

User device(s) 110a, 110b include, generally, a computer or computing device including functionality for communicating (e.g., remotely) over a network 150. Data may be collected from user devices 110a, 110b, and data requests may be initiated from each user device 110a, 110b. User device(s) 110a, 110b may be a server, a desktop computer, a laptop computer, personal digital assistant (PDA), an in- or out-of-car navigation system, a smart phone or other cellular or mobile phone, or mobile gaming device, among other suitable computing devices. User devices 110a, 110b may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110a, 110b may be an electronic device including hardware, software, or embedded logic components or a combination of two or more such components and capable of carrying out the appropriate functions implemented or supported by the user device 110a, 110b. For example and without limitation, a user device 110a, 110b may be a desktop computer system, a notebook computer system, a netbook computer system, a handheld electronic device, or a mobile telephone. The present disclosure contemplates any user device 110a, 110b. A user device 110a, 110b may enable a network user at the user device 110a, 110b to access network 150. A user device 110a, 110b may enable its user to communicate with other users at other user devices 110a, 110b.

A user device 110a, 110b may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110a, 110b may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110a, 110b one or more Hyper Text Markup Language (HTML) files responsive to the HTTP request. The user device 110a, 110b may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110a, 110b may also include an application that is loaded onto the user device 110a, 110b. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

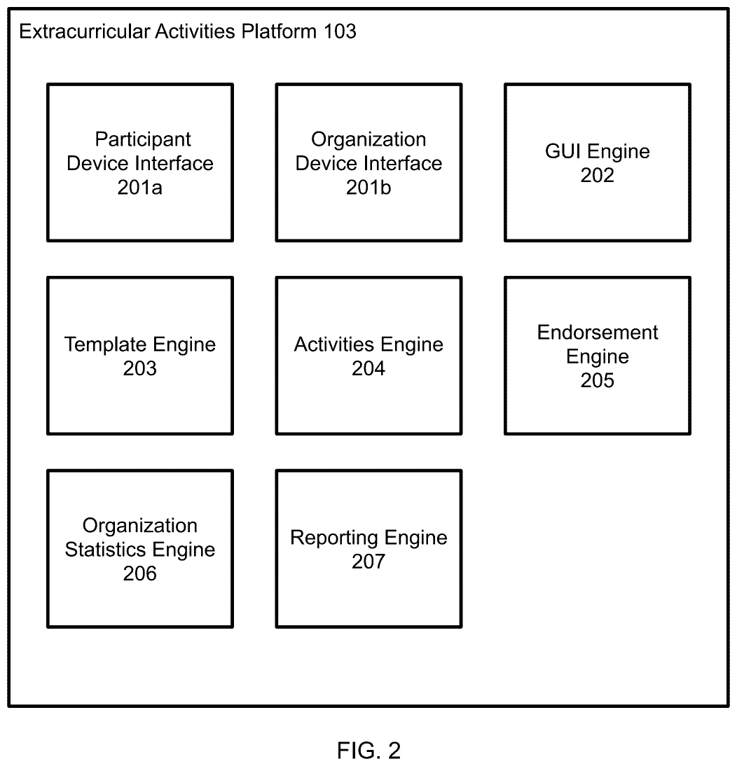

FIG. 2 illustrates an exemplary embodiment of the extracurricular platform 103. The extracurricular platform 103 comprises participant device interface 201a, organization device interface 201b, GUI engine 202, template engine 203, activities engine 204, endorsement engine 205, organization statistics engine 206, and reporting engine 207. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Participant device interface 201a is operable to obtain participant information associated with at least one of registering users on the extracurricular activities platform, obtaining user/participant activity information (e.g. skills and/or achievements information) and obtaining participant generated templates. In one aspect, participant device interface 201a may obtain activity information based on at least one of a template associated with an organization with which the activity information is associated, a template recommended by the template engine 203, and a template defined (at least in part) by the participant/user. In one aspect, participant device interface 201a obtains a participant request for verification of participant activity information.

Organization device interface 201b is operable to obtain organization information associated with at least one of registering users on the extracurricular activities platform, obtaining user/participant activity information, obtaining activity verification information, and obtaining organization generated templates or template information. In one aspect, organization device interface 201a may obtain template information based on at least one of a template recommended for use by the organization and a template defined (at least in part) by an organization. In one aspect, organization device interface 201b obtains organization information associated with verification of participant activity. Information associated with verification of participant activity may comprise at least one of endorsement of the activity, certification of the activity, rejection of the verification request, a request for additional information, and a request to remedy a deficiency associated with the verification request.

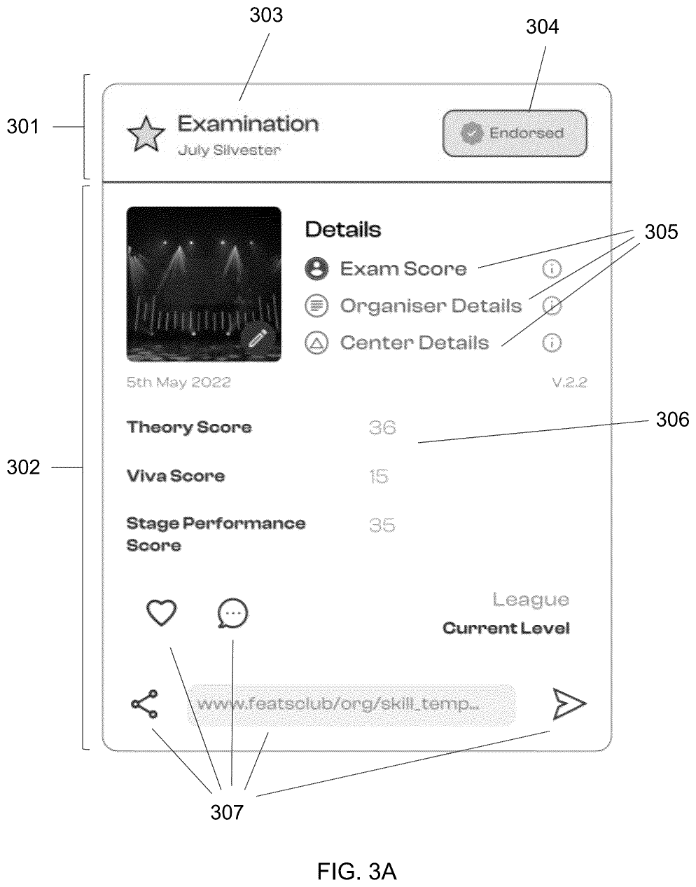

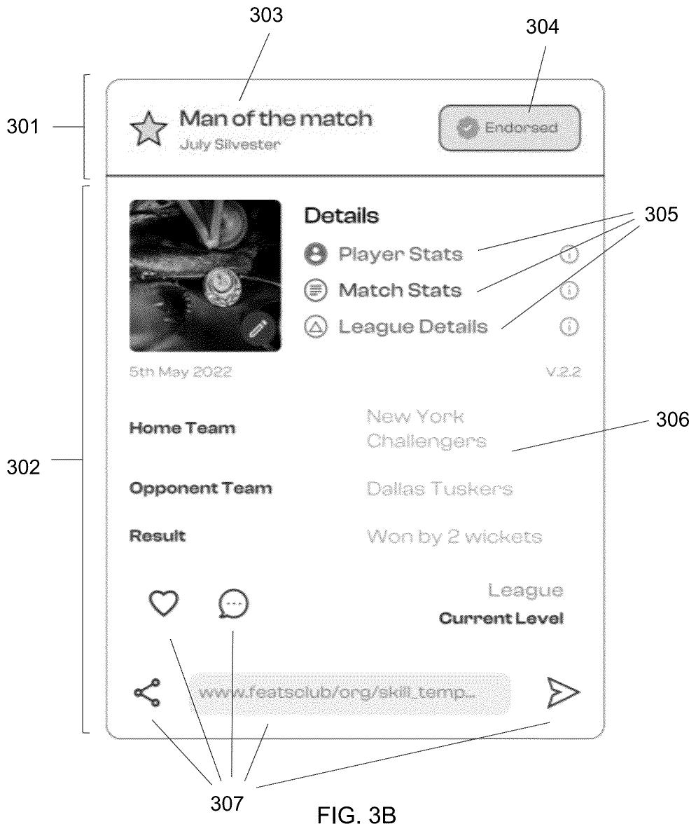

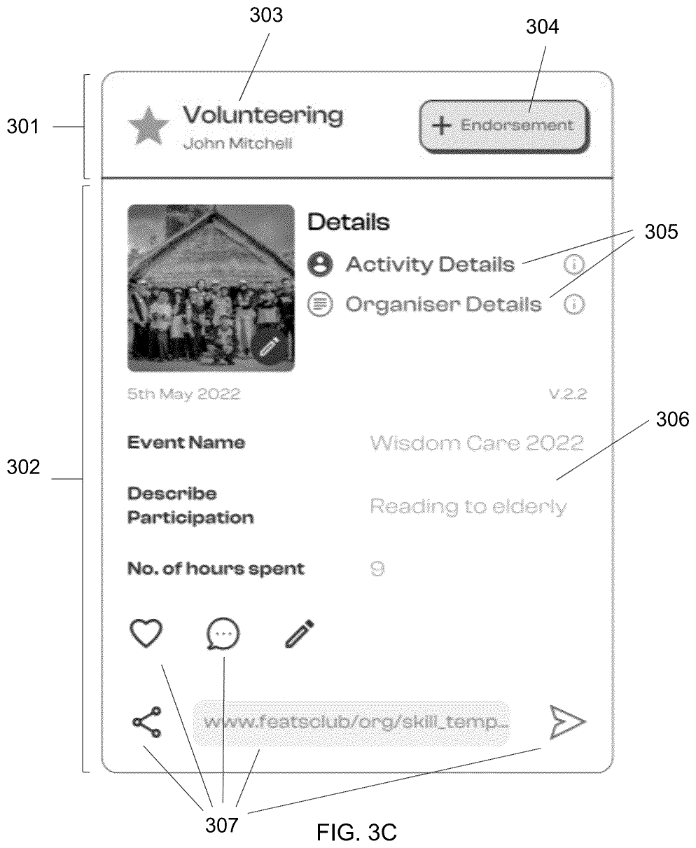

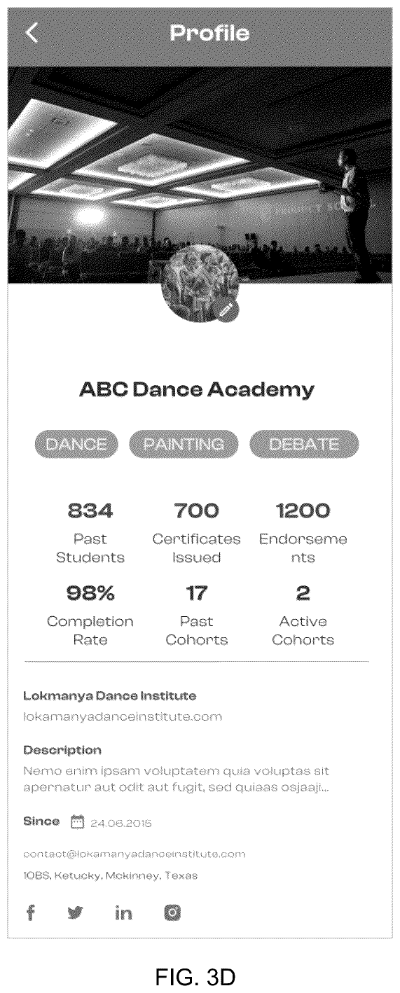

GUI engine 202 is operable to generate at least one GUI for use in obtaining and/or providing activity related information. Exemplary GUIs may comprise various features associated with different aspects of the extracurricular activities platform. GUI engine 202 may update GUIs over time based on user interaction with the platform. For example, as more participant and/or organization based templates are obtained, GUI engine 202 may update the associated GUI(s) based on analysis of the template information by template engine 203. FIGS. 3A-3D illustrate several exemplary GUIs which may be used by GUI engine 202. In one aspect, GUI engine 202 is operable to provide a user interface allowing users to create at least one template. Creating at least one template may comprise GUI engine 202 generating a user interface allowing users to define at least one of a layout of the template and the information contained in the template (e.g. the information that participants will be requested to provide when logging an activity associated with the template).

Template engine 203 is operable to at least one of provide templates for use by at least one of participants and organizations, recommend templates for use (e.g. based on activity type), obtain at least one of participant based template information and organization based template information, analyze template information (e.g. determine most common/popular information associated with user/org provided templates), and recommend templates for use by at least one of participants and organizations based on the template analysis (e.g. the most common/popular information). By analyzing template usage trends and making recommendations, the template engine 203 serves to move towards a standardized format of information associated with each activity thereby allowing for easier comparison of activities between a plurality of different users since users will generally provide the same type of standardized information for a given activity.

Activities engine 204 is operable to at least one of log activity data associated with at least one of participants and organizations and provide data for display via at least one GUI. Activities engine 204 may coordinate storage of activity information in association with a user/participant (e.g. such as via an identifier for associating users/participants with activity information in a database). Activities engine 204 may store information in association with a template used to obtain the information. Activities engine 204 may standardize the format of activity engine for storage such as when information for the same activity type is obtained using different templates.

Endorsement engine 205 is operable to at least one of allow participants to request verification of an activity, allow organizations to review/approve verification requests, and coordinate storage of verification information in association with activity information. At least one of verification requests, verification review/approval, and display of verification results may be provided via at least one GUI (see for example, FIGS. 3A-3D).

Organization statistics engine 206 is operable to track organization statistics over time (e.g. number of past students, events, classes, etc., number of endorsements/certificates provided, % of endorsement requests completed, etc.). Organization statistics engine 206 may provide the organization statistics for display, such as via a GUI, so that individuals can view information about an organization such as an organization which has verified at least one participant activity. Organization statistics engine 206 may compute a score associated with an organization, wherein the score reflects at least one of the experience, expertise, reputation, and recognition associated with the organization. In one aspect, the organization statistics may serve to provide a degree of trustworthiness or otherwise enhance the value associated with user provided activity information since the user provided activity information is not only verified, but the source of the verification (and associated information) can also be viewed.

Reporting engine 207 is operable to generate at least one report associated with at least one activity. Reporting engine 207 may, upon request by a user/participant such as via a GUI, generate a report comprising information associated with an activity. In one aspect, a report may comprise an activity log associated with the activity (e.g. associated with a skill or achievement). The activity log may comprise a list of dates and associated information (duration, location, etc.) for at least one instance for which the participant provided information about the activity. For example, an activity log may comprise, but is not limited to, a list of training sessions associated with a skill (e.g. Taekwondo, dance instruction, etc.), a list of recurring volunteering sessions, a list of performances or matches, etc. Reporting engine 207 may provide a report to at least one of a requesting user/participant and/or may provide a report to at least one designated entity selected or identified by the user/participant (including both platform users and external individuals). In this way, a user is provided with a means of sharing more detailed information about a particular activity (e.g. skill or achievement) which they have logged on the extracurricular activities platform.

FIGS. 3A-3C illustrate exemplary GUIs for use in association with an extracurricular activities platform according to one aspect of the invention. The GUI may comprise at least a first user interface (UI) element 301 and a second UI element 302. The first UI element may comprise at least one of a first subelement 303 and a second subelement 304. The second UI element may comprise at least one first interactive subelement 305 and/or at least one second interactive subelement 307.

The first user interface (UI) element 301 may display general information associated with an activity associated with a participant. The first subelement 303 may display at least one of a name of the activity, a type of the activity, a name of a user/participant associated with the activity, and a date or date range associated with the activity. In one aspect, the first subelement 303 may be or comprise an interactive element wherein interaction therewith results in the display of (e.g. via a new GUI or as an overlay on the existing GUI) a detailed information associated with the activity (e.g. a standardized definition or description of what a skill or achievement entails). For example, a long press or touch/click/tap and hold on the interactive element 303 may result in a popout (e.g. a bubble) or other overlay or display element showing a description associated with the activity, while a short press or tap/click may result in navigation to or display of a different GUI which displays description information associated with the activity. Description information may comprise a general definition or description and/or a detailed breakdown of different masteries or categories of accomplishment (e.g. tiers, levels, styles, etc.) associated with the activity and a corresponding description of what skills and/or achievements are associated with these different masteries or categories. These are merely exemplary interactions and other interactive configurations may be used to display descriptive information about an activity without departing from the scope of the invention as would be apparent to one of ordinary skill in the art.

The second subelement 304 may display at least one of an endorsement status associated with the activity. In one aspect, when the endorsement status is unverified/unendorsed, the icon may not be present on the GUI presented to other users while the GUI presented to the user associated with the activity may display an endorsement request icon (e.g. see FIG. 3C). Interaction with the second subelement when the status is verified or endorsed (e.g. see FIG. 3A or 3B) may result in subsequent display (e.g. via another UI element or GUI) of information associated with the verifier/endorser. Interaction with the second subelement when an endorsement request icon is present may result in submission of a verification request to an organization associated with the activity and/or subsequent display (e.g. via another UI element or GUI) of a verification request screen and associated information. In one aspect, the first UI element 301 may comprise an interactive element which upon interaction results in the display of the second UI element 302 and corresponding information as discussed below.

The second UI element 302 may display detailed information associated with the activity displayed in the first UI element 301. The first interactive subelement 305 may display a category title associated with detailed information of the activity. Category titles may include, but are not limited to, at least one of organizer details, activity details, location details, player statistics, match statistics, league details, and evaluation score. Interaction with the first interactive subelement 305 may result in the display of detailed information 306 associated with the category title within the second UI element and below the interactive subelement 305. The second interactive subelement 307 may comprise at least one icon allowing a user to at least one of like, comment on, and share the information displayed in the first UI element 301 and second UI elements. In one aspect, the information displayed in the first and second UI elements allow users to quickly access and review extracurricular activities and corresponding details across a plurality of different users and determine whether the information associated with the activities has been verified by a third party entity. In one aspect, due to template analysis, optimization and recommendation as described above the information displayed can be presented in a standardized format allowing for even easier comparison of details across a plurality of users. In one aspect, the all UI elements may be arranged and displayed such that they fit within a smartphone viewport.

FIG. 3D illustrates an exemplary GUI for use in providing information associated with an organization. The GUI may display at least one of an organization name, categories of activities with which the organization is associated (e.g. dance, painting, debate), number of past students, number of verifications issued (such as number of certificates issues and/or number of endorsements each of which can be inspected in detail via interaction through the GUI), completion percentage, past cohorts, active/ongoing cohorts, an organization score or rating indicative of at least one of organization experience, expertise, reputation, and recognition. This is merely one example of the information that may be displayed in association with an organization and the arrangement of such information and different information and/or arrangements may be used without departing from the scope of the invention as would be apparent to one of ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

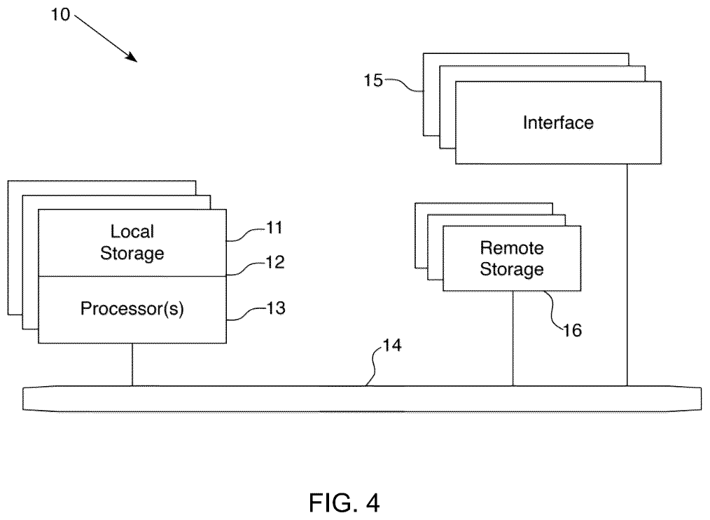

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components or the like may be and/or comprise hardware and/or software as described herein. For example, the extracurricular activities platform 103 and subcomponents thereof may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

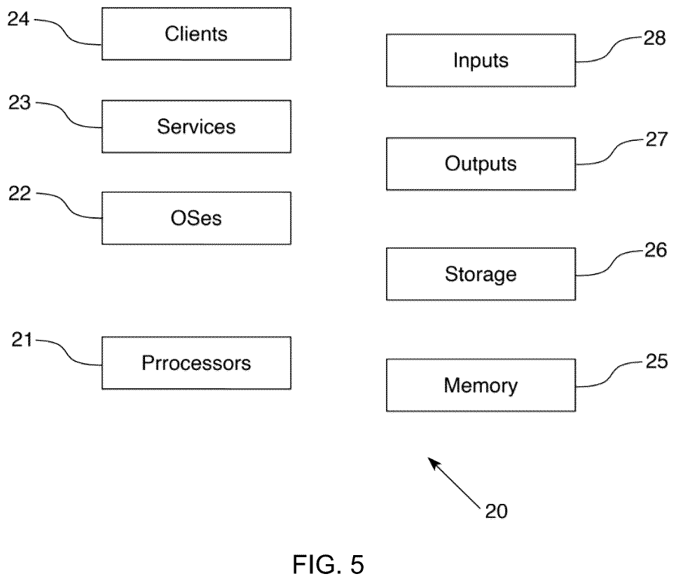

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

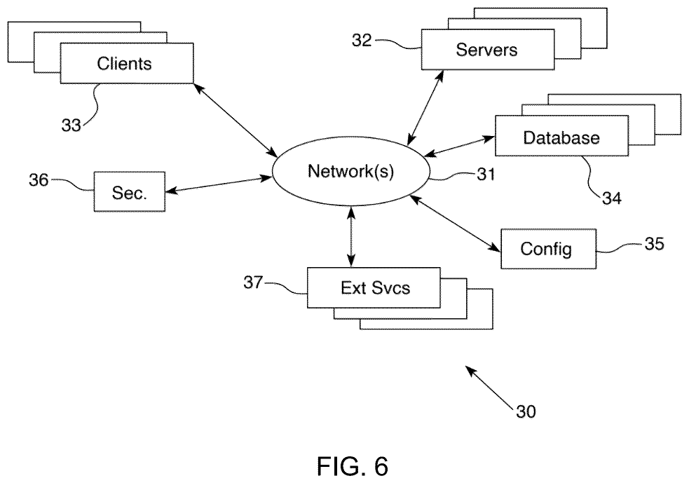

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

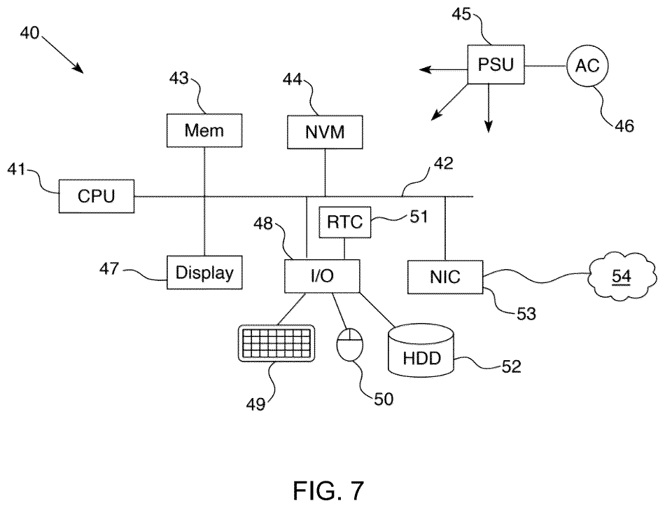

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A graphical user interface for use with an extracurricular activity logging platform, the graphical user interface allowing viewing and sharing extracurricular activities and associated information, the graphical user interface comprising:
a first user interface (UI) element displaying general information associated with an activity associated with a user, the first UI element comprising:
a first sub-element displaying a title of the associated activity;
a second sub-element disposed to the right of the first sub-element, the second sub-element displaying an endorsement status associated with the activity;
a second UI element disposed below the first UI element, the second UI element displaying detailed information associated with the activity, the second UI element comprising:
at least one first interactive sub-element displaying a category title associated with detailed information of the activity, wherein interaction with the at least one first interactive sub-element results in displaying detailed information associated with the category title, wherein the detailed information is displayed within the second UI element and below the at least one interactive sub-element;
at least one second interactive sub-element displaying an icon allowing a user to at least one of like, comment on, and share the information displayed in the first and second UI elements, wherein the information displayed in the first and second UI elements allow users to quickly access and review extracurricular activities and corresponding details across a plurality of different users and determine whether the information associated with the activities has been verified by a third party entity.

2. The graphical user interface according to claim 1, wherein the activity comprises a skill or achievement associated with at least one of athletics, volunteering, fundraising, exercise, training, and an examination.

3. The graphical user interface according to claim 1, wherein the second subelement is an interactive element which allows users to request an endorsement associated with the activity.

4. The graphical user interface according to claim 1, wherein the second subelement is an interactive element which allows users to view information associated with an endorser.

5. The graphical user interface according to claim 4, wherein the information associated with an endorser comprises at least one of a number of previous endorsements, a number of previous certifications, a completion percentage, a number of previous activity participants associated with the endorser, and a number of ongoing activities associated with the endorser.

6. The graphical user interface according to claim 1, wherein the at least one second interactive sub-element displaying an icon allowing a user to share the information displayed in the first and second UI elements comprises at least one of an interactive element to share the information with individuals outside the platform and an interactive element to share with other users of the platform.

7. The graphical user interface according to claim 1, wherein at least one of the first UI element and the second UI element displays a date or date range associated with the activity.

8. The graphical user interface according to claim 1, wherein the first sub-element further displays the name of the user associated with the activity.

9. The graphical user interface according to claim 1, wherein the detailed information comprises at least one of event name, event type, user performance details, user performance statistics, match statistics, match participants, match outcome, league details, organizer details, activity details, location details, duration, an evaluation type, and an evaluation result.

10. The graphical user interface according to claim 1, wherein the detailed information is obtained in association with at least one template.

11. The graphical user interface according to claim 10, wherein the template is determined from at least one of a recommended template recommended for use by organizations, edits by at least one organization to the recommended template, and custom templates generated by organization users.

12. The graphical user interface according to claim 10, wherein the template is designed to obtain and provide standardized information for a given activity across a plurality of different users and organizations thereby allowing for easier comparison of activities between a plurality of different users.

13. The graphical user interface according to claim 1, wherein the category title comprises at least one of organizer details, activity details, location details, player statistics, match statistics, league details, and evaluation score.

14. The graphical user interface according to claim 1, the first UI element comprises a rectangle having a horizontal dimension greater than a vertical dimension.

15. The graphical user interface according to claim 1, wherein the first UI element and second UI element have the same horizontal dimension.

16. The graphical user interface according to claim 1, wherein the first UI element and second UI element have different vertical dimensions.

17. The graphical user interface according to claim 1, wherein all UI elements fit within a smartphone viewport.

18. The graphical user interface according to claim 1, wherein the first sub-element displaying a title associated with the activity comprises an interactive element wherein interaction with the interactive element results in the display of descriptive information associated with the activity.

19. The graphical user interface according to claim 18, wherein the descriptive information comprises at least one of a standardized definition of the activity and standardized categories of mastery associated with the activity.
